(19) United States
(12) Patent Application Publication
(10) Pub. No.: US 2004/0126641 A1
(43) Pub. Date: Jul. 1, 2004

(54) Regenerative fuel cell electric power plant and operating method

(76) Inventors: Martin T. Pearson, Burnaby (CA); Eric W. Fuller, (US); Patricia S. Chong, (US); Patrick Koropatnick, (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/331,124

(22) Filed: Dec. 27, 2002

(51) Int. Cl. H01M 8/02; H01M 16/00; H01M 8/10; H01M 8/04; H01M 8/24

(52) U.S. Cl. 429/34; 429/9; 429/32

(57) ABSTRACT

In one embodiment, an electric power plant comprises an array of fuel cell systems, the fuel cell systems each comprising a regenerative fuel cell stack, an oxidant supply system for supplying an oxidant gas to the stacks, a fuel supply system for supplying a fuel gas to the stacks, a system for supplying a humidified carrier gas to the stacks, a DC current supply system for connecting a power source across the stacks, and a storage system for storing hydrogen received from the stacks. In power generation mode, the fuel cells of the present power plant generate electricity for supply to one or more electrical loads. In electrolysis mode, the stacks generate hydrogen from a humidified carrier gas stream.

### BACKGROUND OF THE INVENTION

1. Field of the Invention

The present invention relates to fuel cell electric power plants and methods of operating them. In particular, the present invention relates to regenerative fuel cell electric power plants and associated operating methods.

2. Description of the Related Art

Fuel cells are known in the art. Fuel cells electrochemically react a fuel stream comprising hydrogen and an oxidant stream comprising oxygen to generate an electric current. Fuel cell electric power plants have been employed in transportation, portable and stationary applications.

Stationary and portable applications include distributed power generation, back-up power, peak power, and uninterruptible power supply (UPS) systems. Distributed power generation relates to providing electrical power to residential, commercial and/or industrial customers instead of, or as a supplement to, the utility power grid. Power plants in such applications typically operate continuously. They are particularly suited to situations where the power grid is not available or sufficiently reliable. Peak power systems are intended to supplement the power grid, providing electrical power intermittently during periods of peak use when sufficient grid power may not be available or when the rate charged by the utility increases. Back-up power and UPS systems provide electrical power during periods when the power grid, or other primary power source, is unavailable.

In addition, UPS systems must be able to provide power to the consumer substantially continuously: they must be “instant on” so that the loss of grid power does not result in an interruption of power supply to the consumer. Consumers who rely on electronic equipment, for example, cannot tolerate even minor interruptions in power supply. In this regard, the Information Technology Industry Council has issued guidelines for voltage dropouts, which are not to exceed 20 milliseconds. In this context, a voltage dropout includes both severe RMS voltage sags and complete interruptions of the applied voltage.

Conventional back-up power and UPS systems employ rechargeable battery banks for supplying electric power when the power grid is interrupted. For applications where a relatively short run time is acceptable, battery banks may be the sole source of back-up power. Where longer run times are required, however, such systems also employ a generator to supply power. In this case, the battery banks provide immediate power until the generator can come online.

Valve regulated lead acid (VRLA) batteries are most often employed in the battery banks. The number of batteries depends on the required run time. For lower power applications (2-7.5 kW), run times of 15 minutes or less are common; other systems employing batteries alone may require run times of 4-8 hours, or more. Current limits are set on re-charging of batteries to avoid damaging them. In practice, VRLA batteries are recharged at a 6×-10× rate, that is, the time to fully re-charge the batteries is six to ten times longer than their run time.

These conventional power supply systems have several significant disadvantages. For example, particularly in applications requiring extended battery run time (e.g., >4 hr), VRLA battery banks are large and heavy. A large battery bank requires a significant amount of indoor floor space for installation, which can be expensive. In addition, the weight of the battery bank may require indoor floor space with increased loading capacity, further increasing cost. Environmental regulations relating to the storage and operation of VRLA batteries also add to increased installation costs. Operating and maintaining a generator further adds to the cost and complexity of systems employing them.

Back-up power and UPS systems employing fuel cell electric power plants have also been described. The described systems have several disadvantages relating to the supply of reactants to the fuel cells, the time it takes for the fuel cells to produce full power, and their surge demand capacity, for example.

Reactants must be supplied to the fuel cells in order to generate electricity. Hydrogen may be supplied from a storage unit, such as pressurized gas or metal hydride tanks. Alternatively, the fuel cell power plant may include a fuel processing system for reforming a hydrocarbon fuel to generate hydrogen. In the former case, hydrogen storage capacity must be sufficient to enable the desired run time of the fuel cells: for extended run times the bulk and/or cost of hydrogen storage, particularly metal hydrides, can be undesirably high. At present, the cost of replenishing stored hydrogen is also higher than desired. Reforming fuel to provide hydrogen can reduce or eliminate the need to store hydrogen, but the associated fuel processing system increases the cost and complexity of the power plant.

Fuel cell output is proportional to the amount of reactants supplied. On start-up, there is typically a delay until the fuel cells reach full operating power. For this reason, back-up or UPS systems solely employing fuel cells are inadequate for some applications because they are not “instant on”. One approach has been to keep the fuel cells in such systems continuously running: either supplying power to the load or in a low output “stand-by” mode. While this approach improves response time, it further exacerbates hydrogen storage issues by significantly increasing hydrogen consumption. In addition, operational lifetime of the power plant may be adversely affected compared to systems where the power plant is operated intermittently.

Fuel cells can be damaged if the load requirements exceed their maximum output. Thus, in power plants solely employing fuel cells, the rated output of the fuel cell stack is generally matched to the expected peak load. In applications where transient load increases are significantly higher than normal load requirements, this necessitates a larger size and output fuel cell stack than required for normal operation in order to deal with surge demand. This, in turn, undesirably increases the cost of the power plant.

Another approach employs hybrid power plants including fuel cells and secondary batteries. The secondary batteries can provide power while the fuel cells come on line, so that the power plant can be “instant on”. The batteries can also provide surge demand capability. These systems, however, do not adequately address the hydrogen supply issues discussed above.

Fuel cell power plants employing electrolysis cells have also been described. Hydrogen (and oxygen) formed by electrolyzing water can be used to replenish or supplement stored hydrogen, alleviating hydrogen storage problems. However, in power plants employing separate fuel cell and electrolysis cell stacks, the additional cost and complexity of the system related to the electrolysis function offset this advantage.

Power plants employing regenerative fuel cell stacks, i.e., stacks that can be operated as fuel cells to generate electricity and as electrolysis cells to generate reactants, have also been described. These power plants can also have disadvantages. For example, the liquid water supplied to the anodes and/or cathodes of the stack needs to be removed from the stack before it can generate electricity, and this can exacerbate the delay in reaching full operating power mentioned earlier. As another example, introducing water into the stack may cause some fuel cell components, such as catalyst particles, to be washed out of the stack, which can adversely impact performance and/or lifetime of the stack.

It is desirable to have a fuel cell electric power plant that requires less space than conventional systems employing VRLA batteries and that more efficiently utilizes stored hydrogen. Further, it is desirable to increase the reliability of the power supply, without significantly increasing the cost. Thus, a less costly, less complex and/or more efficient approach to fuel cell-based power plants is desirable. The present invention addresses the disadvantages of conventional power supply systems and provides further related advantages.

### BRIEF SUMMARY OF THE INVENTION

In one embodiment, the present electric power plant comprises: a power supply system comprising fuel cell systems each comprising a regenerative fuel cell stack; an oxidant supply system for supplying an oxidant gas to the stacks; a fuel supply system for supplying a fuel gas to the stacks; a system for supplying a humidified carrier gas to the stacks; a DC current supply system for connecting a power source across the stacks; and, a storage system for storing hydrogen received from the stacks.

In some embodiments, the power supply system comprises a power bus, a first fuel cell system, a first switch selectively operable to electrically couple the first fuel cell system in series in the power bus, a second fuel cell system, and a second switch selectively operable to electrically couple the second fuel cell system in series in the power bus.

In another embodiment, the present electric power plant comprises: an array of fuel cell systems, the fuel cell systems each comprising a regenerative fuel cell stack; an oxidant supply system for supplying an oxidant gas to the stacks; a fuel supply system for supplying a fuel gas to the stacks; a system for supplying a humidified carrier gas to the stacks; a DC current supply system for connecting a power source across the stacks; and, a storage system for storing hydrogen received from the stacks.

In some embodiments, the array comprises a power bus and a first arm comprising a first plurality of fuel cell systems electrically couplable to the power bus and electrically couplable in series to each other. In other embodiments, the array further comprises a second arm comprising a second plurality of fuel cell systems electrically couplable to the power bus and electrically couplable in series to each other, the second arm electrically couplable in parallel to the first arm. The array may include at least one redundant fuel cell system, if desired.

The present power plant may be configured as a DC power plant or as an AC power plant. In some embodiments, the present power plant further comprises a rectifier electrically connected to an AC power source. In other embodiments, the power plant further comprises an inverter electrically connected to the array.

### BRIEF DESCRIPTION OF THE DRAWING(S)

FIG. 1 is a schematic illustration of a conventional DC back-up power or UPS system.

FIG. 2 is a schematic illustration of a conventional AC back-up power or UPS system.

FIG. 3 is a schematic diagram of a power supply system powering a load, the power supply system including a number of individual fuel cells systems forming a one-dimensional array of fuel cell systems electrically couplable in series to provide a desired power at a desired voltage and a desired current to the load.

FIG. 4 is a schematic diagram of a power supply system including a number of fuel cell systems forming a two-dimensional array of fuel cell systems electrically couplable in a variety of series and parallel combinations.

FIG. 5 is a plot of stack potential versus stack current for PEM fuel cell stack operated in power generation mode and electrolysis mode.

FIGS. 6a and 6b are schematic illustrations of a conventional 400 A 4 hour power supply employing VRLA battery banks and a comparable embodiment of the present power plant, respectively.

FIGS. 7a and 7b are schematic illustrations of a conventional 400 A 8 hour power supply employing VRLA battery banks and a comparable embodiment of the present power plant, respectively.

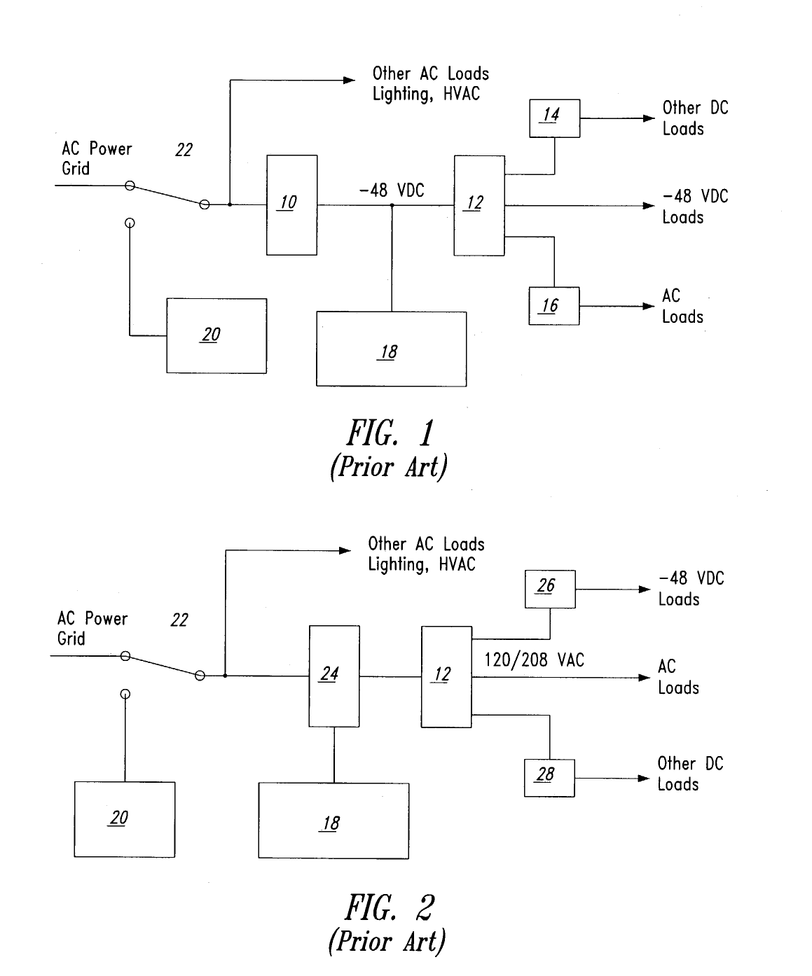

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE INVENTION

In the following description, certain specific details are set forth in order to provide a thorough understanding of the various embodiments of the invention. However, one skilled in the art will understand that the invention may be practiced without these details. In other instances, well-known structures associated with fuel cells, fuel cell stacks, batteries and fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

In one embodiment, the present power plant comprises: a power supply system comprising an array of fuel cell systems, each of the fuel cell systems comprising a regenerative fuel cell stack; reactant supply systems for supplying an oxidant gas and a fuel gas to the stacks when operating in power generation mode; a system for supplying a humidified carrier gas to the stacks when operating in electrolysis mode; a DC current supply system for connecting a power source to the stacks for operation in electrolysis mode; and, a storage system for storing hydrogen produced during electrolysis.

Fuel Cell Array

As previously mentioned, the present power plant comprises an array of fuel cell systems. Each fuel cell system comprises a fuel cell stack electrically couplable to the other stack(s) in the array. The particular type of fuel cells making up the stacks is not essential to the present power plant, and persons skilled in the art can readily select suitable fuel cells for a given application. For example, in some embodiments of the present power plant, polymer electrolyte membrane (PEM) fuel cell stacks are employed.

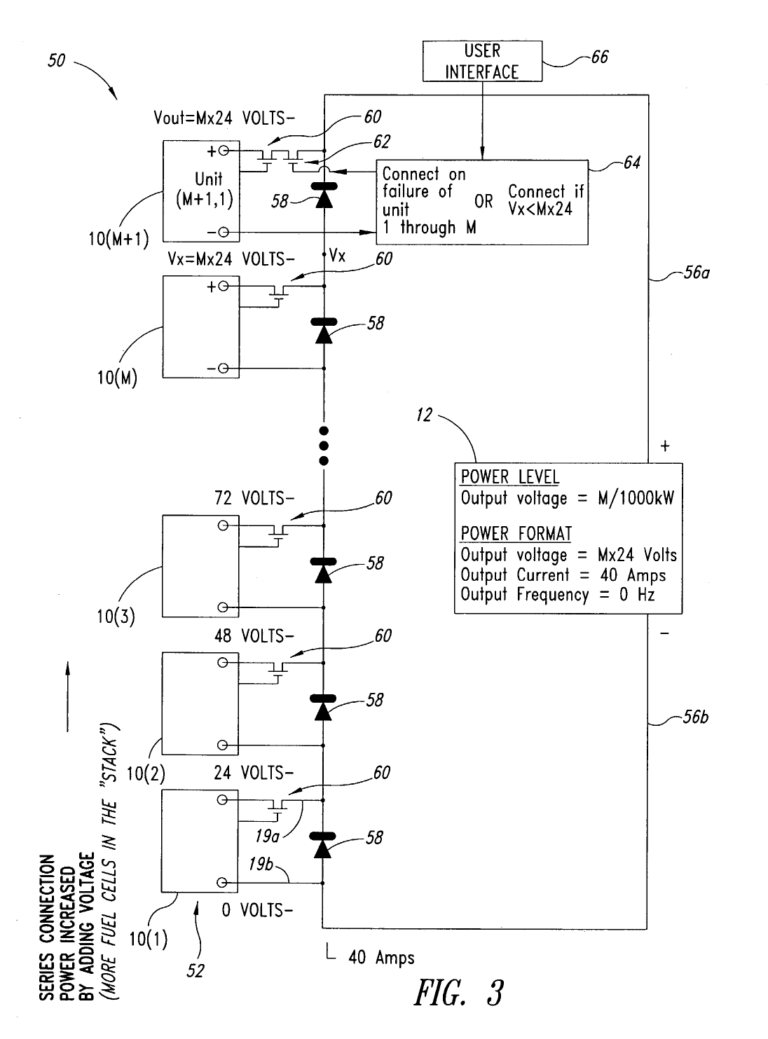

FIG. 3 shows one embodiment of a power generation system 30 including a one-dimensional array 32 of fuel cells systems, collectively referenced as 40, that are electrically couplable in series to positive and negative voltage rails 34a, 34b, respectively, that form a power bus 34 for supplying power to the load 36. A respective diode, collectively referenced as 38, is electrically coupled between the positive and negative outputs of each of the fuel cell systems 40. The illustrated power generation system 30 includes a number M+1 fuel cell systems, which are individually referenced as 40(1)-40(M+1), the number in the parenthesis referring to the position of the fuel cell system 40 in the array. The ellipses in FIG. 3 illustrate that the power generation system 30 may include additional fuel cell systems (not explicitly shown) between the third fuel cell system 40(3) and the M^{th} fuel cell system 40(M). One or more of the fuel cell systems (e.g., 40(M+1)) may serve as a “redundant” fuel cell system, being electrically coupled in series on the power bus 34 as needed, for example, when one of the other fuel cell systems 40(1)-40(M) is faulty or when the load 36 requires additional power or voltage.

The power generation system 30 may employ one or more fault switches, such as a contactor or transistor 42 that can automatically disconnect a respective fuel cell system 40 in the event of a fault or failure. For example, the fault transistor 42 may open upon a fault or failure in the fuel cell system's 20 own operating condition or upon a fault or failure in the operating condition of the power generation system 30.

The power generation system 30 may employ one or more redundancy switches, such as a contractor or transistor 44, that can manually or automatically electrically couple a respective fuel cell system 40(M+1) to the power bus 34 based on a condition other than the fuel cell system's 40(M+1) own operating condition. For example, where another fuel cell system 40 is faulty, the redundancy transistor 44 may close to electrically couple the redundant fuel cell system 40(M+1) to the power bus 34 to maintain the power, voltage and current to the load 36. Also for example, where a higher output power is desired, the redundancy transistor 44 may close to electrically couple the redundant fuel cell system 40(M+1) to the power bus 34 to adjust the power, voltage and current to the load 36.

While manual operation may be possible, the power generation system 30 may include control logic 46 for automatically controlling the operation of the redundancy switch (e.g., transistor 44).

The control logic 46 may receive an input from one or more of the other fuel cell systems 40(1)-40(M), the input relating to an operating condition of the respective fuel cell system 40(1)-40(M) (i.e., “connect on failure of Unit 1 through M”). For example, the control logic 46 may receive voltage, current and/or power measurements related to the fuel cell stack and/or electrical storage of the fuel cell system 40. Such measurements may include, but are not limited to, stack current I_{S}, stack voltage V_{S}, battery current I_{B}, and battery voltage V_{B}, and/or temperature. Also for example, the control logic 46 may receive logical values relating to the operating condition of various systems of the fuel cell system 40, including, but not limited to, an ambient hydrogen level, an ambient oxygen level, and a reactant flow. In this respect, reference is made to commonly assigned U.S. application Ser. No. 09/916,240, filed Jul. 25, 2001 and entitled “FUEL CELL SYSTEM METHOD, APPARATUS AND SCHEDULING” (Atty. Docket No. 130109.409).

Additionally, or alternatively, the control logic 46 may receive an input from other components of the power generation system 30, such as voltage and current sensors coupled to determine a voltage or current at various points on the power bus 34. For example, the control logic 46 may receive a voltage reading corresponding to the voltage across the power bus measured at a “top” of the one-dimensional array 32, allowing the control logic 46 to indirectly detect a fault in one or more of the fuel cell systems 40 by detecting a measurement below an expected threshold value (i.e., “connect if V_{X}<M×24V”). The threshold for detecting a fault condition may be predefined in the control logic 46 or may be set by a user or operator via a user interface 48 such as analog or digital controls, or a graphical user interface on a special purpose or general purpose computer.

Additionally or alternatively, the control logic 46 may receive an input from the user or operator via the user interface 48 which may include a set of user controls to set operating parameters such as power, voltage, and or current thresholds, to set desired parameters such as desired power, desired voltage or desired current nominal values, to provide electrical configuration information, to provide switching signals, and/or to signals to override the automatic operating aspects of the control logic 46. The user interface 48 may be remote from the remainder of the power generation system 30. The control logic 46 can be embodied in one or more of hardwired circuitry, firmware, micro-controller, application specific processor, programmed general purpose processor, and/or instructions on computer-readable media.

Provided the output voltage of the fuel cell systems 40 can be adequately controlled, the series coupling of the fuel cell systems 40 is possible. Thus any desired number of fuel cell systems 40 may be electrically coupled in series to realize any integer multiple of voltage output of the individual fuel cell system 40. For example, where each fuel cell system 40 produces 24 volts across the rails 50a, 50b, three fuel cell systems 40(1)-40(3) are electrically couplable to produce 72 volts across the power bus 34. More generally stated, a number M of fuel cell systems 40 can be electrically coupled in series to produce M times the nominal fuel cell system voltage across the power bus 34. Additionally, the series coupling renders the position of the redundant fuel cell system 40(M+1) in the one-dimensional array 32 unimportant.

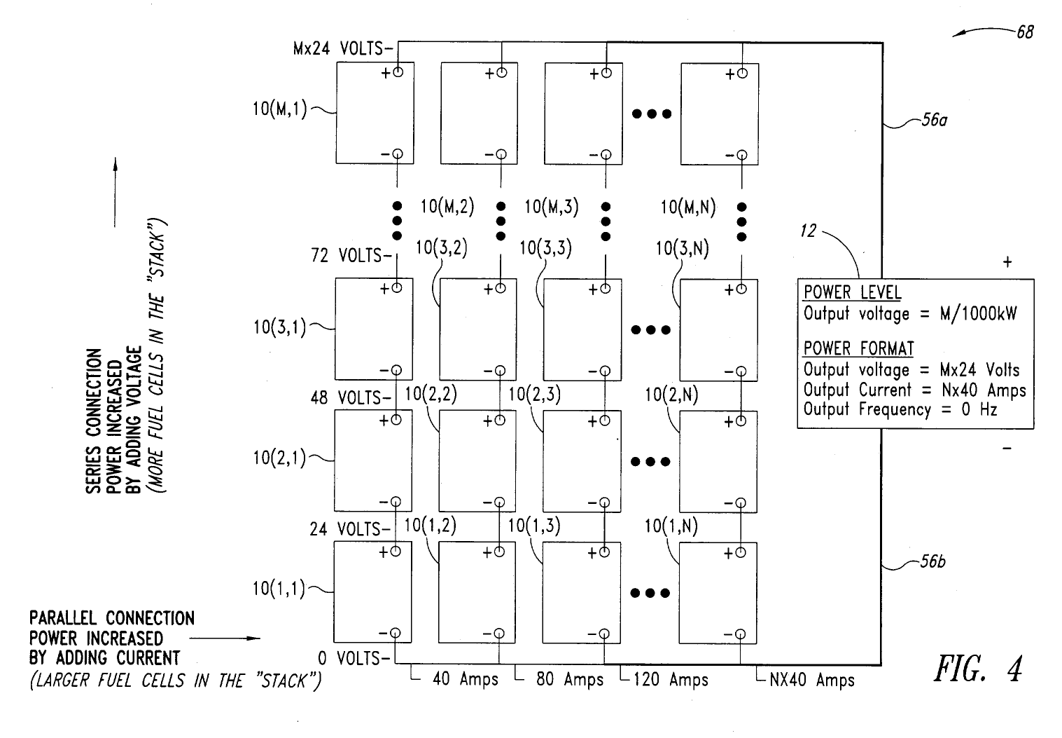

FIG. 4 shows a two-dimensional array 60 of fuel cell systems 40, arranged in a number M of rows and a number N of columns for powering the load 36 via the power bus 34. The fuel cell systems 40 are individually referenced 40(1,1)-40(M,N), where the first number in the parenthesis refers to a row position and the second number in the parenthesis refers to a column position of the fuel cell system 40 in the two-dimensional array 60. The ellipses in FIG. 4 illustrate that the various rows and columns of the two-dimensional array 60 may include additional fuel cell systems (not explicitly shown). The diodes 38, fault and redundancy switches 42, 44, respectively, control logic 46, and user interface 48 have been omitted from FIG. 4 for clarity of illustration.

Each of the fuel cell systems 40(1,1)-40(M,N) is individually couplable to the power bus 34 to provide a variety of desired output power, voltage or current. The fuel cell systems 40(1-M,1), 40(1-M,2), 40(1-M,3)-40(1-M,N) in each column 1-M are electrically couplable in series to one another. The fuel cell systems 40(1,1-N), 40(2,1-N), 40(3,1-N)-40(M,1-N) in each row 1-N are electrically couplable in parallel to one another. From FIG. 4 and this description, one skilled in the art will recognize that the two-dimensional array 60 permits the series coupling of fuel cell systems 40 to adjust an output power of the power generation system 30 by adjusting an output voltage. One skilled in the art will also recognize that the two-dimensional array 60 permits the parallel coupling of fuel cell systems 40 to adjust the output power of the power generation system 30 by adjusting an output current. One skilled in the art will further recognize that the two-dimensional array 60 permits the series and parallel coupling of fuel cell systems 40 to adjust the output power of the power generation system 30 by adjusting both the output current and the output voltage. Thus, for the illustrated embodiment where each fuel cell system produces, for example, 1 kW at 24 volts and 40 amps, a maximum output power of N×M kW is possible. One skilled in the art will further recognize that the one- and two-dimensional array structures discussed herein refer to electrically couplable positions relative to one another, and do not necessary require that the fuel cell systems 40 be physically arranged in rows and/or columns.

The fuel cell systems may further comprise an electrical storage device such as a super capacitor and/or a battery electrically coupled in parallel with the fuel cell stack across a high voltage bus to power the load. The open circuit voltage of the battery is selected to be similar to the full load voltage of the fuel cell stack. An internal resistance R_{B} of the battery is selected to be much lower than the internal resistance of the fuel cell stack. Thus, the battery acts as a buffer, absorbing excess current when the fuel cell stack produces more current than the load requires, and providing current to the load when the fuel cell stack produces less current than the load requires. An optional reverse current blocking diode may be electrically coupled between the fuel cell stack and the battery to prevent current from flowing from the battery to the fuel cell stack. A drawback of the reverse current blocking diode is the associated diode voltage drop. The fuel cell system may also include other diodes, as well as fuses or other surge protection elements to prevent shorting and/or surges.

Reactant Supply Systems

The oxidant gas can be pure oxygen or an oxygen-containing gas, such as air. In the former case, the oxidant supply system may include a stored oxygen supply; in the latter case, air may be supplied to the stack at ambient or higher pressure. Where higher pressure operation is desired, gas compression equipment, including compressors, blowers, pumps, boosters, or ejectors, may be employed. Single- and multi-stage compression may be employed, as desired.

The fuel supply system includes hydrogen storage equipment for storing the hydrogen fuel supplied to the stack during power generation mode. The hydrogen fuel may be substantially pure hydrogen. If desired, the fuel supply and hydrogen storage systems may share common hydrogen storage equipment. In some embodiments, these systems form an integrated system for supplying and storing hydrogen to the stack.

Either or both of the incoming reactant streams may be humidified before being directed to the stacks. The means for humidifying the reactant stream(s) is not essential to the present power plant and operating method, and persons skilled in the art can readily select suitable such means for a given application. For example, the reactant stream(s) may be humidified in a membrane exchange humidifier that also receives the reactant exhaust from the stacks. Alternatively, a fine stream of water may be injected into the reactant stream(s). As a further example, the reactant stream(s) may be humidified by contact with hot water. Other suitable means, including enthalpy wheels or pressure swing adsorption (PSA) units, will be apparent to persons skilled in the art. Humidification of the reactant streams is not required, however. For example, ambient air may be supplied to the stack without humidification.

Carrier Gas Supply System

The humidified carrier gas supply system supplies water to the stack that is electrolyzed during electrolysis mode. The water is present as vapor and/or droplets entrained in a carrier gas. The carrier gas may comprise air or an inert gas, such as nitrogen, for example. In some embodiments, the oxidant and humidified gas or carrier gas are the same and the associated supply systems may share common components. Indeed, in further embodiments, an integrated system supplies the oxidant and humidified gas to the stack.

The means for humidifying the carrier gas is not essential to the present power plant and operating method, and persons skilled in the art can readily select suitable such means for a given application. For example, any of the foregoing humidification means described for humidifying the reactant streams may be employed. Other suitable such means will be apparent to persons skilled in the art.

In some embodiments of the present power plant, the humidified carrier gas supplied to the stack in electrolysis mode is ambient air. In further embodiments, both the oxidant stream and the humidified carrier gas are ambient air. The PEM fuel cells and method of operation described in U.S. Pat. No. 6,451,470, for example, may be employed for the stacks in such embodiments.

DC Current Supply System

The DC current supply system comprises a power supply electrically couplable across the fuel cell stacks during electrolysis mode. The DC current supply system may also include circuits and associated controls for pulsing the stacks during electrolysis mode to maintain or recover performance of the present power plant, as will be discussed in further detail, below. In some embodiments, the DC current supply is a rectifier connected to the grid. The selection of DC current supply is not essential to the present power plant, however, and any suitable DC power source capable of providing DC current to the stacks at a voltage greater than the stack open circuit voltage may be employed.

In embodiments where the fuel cell systems comprise an electrical storage device such as a super capacitor and/or a battery electrically coupled in parallel with the fuel cell stack, the DC current supply system may also be adapted to recharge the electrical storage devices, if desired.

Hydrogen Storage System

During electrolysis, hydrogen is directed from the stacks to a hydrogen storage system. The type of hydrogen storage is not essential to the present power plant. For example, hydrogen may be stored as a pressurized gas or a liquid, if desired. Alternatively, solid hydrogen storage media may be employed, including metal hydride (e.g., nickel metal hydride), chemical hydride (e.g., borohydrides) or carbon nanomaterials. Low pressure hydrogen gas storage suffers from relatively low volumetric and gravimetric energy densities, but is relatively inexpensive and simple to implement. As the pressure of the stored hydrogen increases, volumetric and gravimetric energy density increases. Metal hydrides exhibit superior volumetric energy densities, but their weight results in significantly inferior gravimetric energy densities compared to other hydrogen storage approaches. Associated temperature regulating equipment—metal hydrides are typically cooled to facilitate hydrogen adsorption and heated to facilitate hydrogen release—and (optionally) gas pressurizing equipment can also add cost and complexity to the overall power plant. Liquid hydrogen storage exhibits good volumetric and gravimetric energy densities, but the associated temperature regulating equipment required to maintain cryogenic storage also adds cost and complexity to the power plant. In addition, liquid hydrogen storage equipment experiences evaporative losses (“boil-off”) over time. Thus, the choice of hydrogen storage equipment for a given application balances various factors, including the size and weight of the equipment, cost and complexity of operation. Persons skilled in the art will be aware of such considerations and can readily select suitable hydrogen storage equipment for a given application.

The electrolysis hydrogen stream exiting the stacks may also contain water that, if not removed, can accumulate undesirably in the hydrogen storage system. This is the case in PEM cells, for example, where hydrogen ion transport is accompanied by water transport across the membrane. Some types of hydrogen storage, such as hydrides, for example, are only suitable for storing dry, high-purity hydrogen. Thus, in some embodiments of the present power plant, the hydrogen storage system may comprise means for removing water from the hydrogen stream before introducing it into the hydrogen storage. For example, hydrogen purification or gas drying equipment useful for this purpose may be employed, including hydrogen-permeable membrane separators (e.g., Pd or Pd alloy membranes), drying tubes (e.g., Nafion™ tubes), PSA units, desiccants or adsorbers, and condensers, for example. In other embodiments where the hydrogen storage is relatively insensitive to the presence of water, a knockout drum may also be employed. The hydrogen storage equipment could also be adapted to allow water that collects therein to be drained, if desired. The selection of particular apparatus for removing water from the electrolysis hydrogen stream, if employed, is not essential to the present power plant and persons skilled in the art can readily choose suitable such apparatus for a given application.

Water from the dry hydrogen gas may be vented to the atmosphere or recovered to increase the water conservation efficiency of the power plant, if desired. Recovered water may be used to humidify the carrier gas and/or the reactant gases, for example. Similarly, water may also be recovered from the anode and/or cathode exhausts and stored for humidification and/or electrolysis purposes.

The hydrogen storage system also comprises means for moving hydrogen from the stack to the hydrogen storage. Such means may be active or passive, and may include means for compressing the electrolysis hydrogen gas.

In some embodiments, the pressure of hydrogen in the hydrogen storage equipment exceeds the pressure of the electrolysis hydrogen exiting the stack. For example, the stacks may operate at ambient pressure while the hydrogen storage system comprises compressed hydrogen tanks, which can store hydrogen at pressures of up to 700 bar (10,000 psi) or more. The hydrogen storage system may therefore comprise means for compressing the electrolysis hydrogen gas stream, such as a compressor, to at least a storage pressure. Other suitable compressing means may be employed, including blowers, pumps, boosters, or ejectors, for example. Single- and multi-stage compression may be employed, as desired. The selection of gas compressing means, if employed, is not essential to the present power plant and persons skilled in the art can readily select suitable gas compressing means for a given application.

Correspondingly, the hydrogen storage system may also comprise means for reducing the pressure of the hydrogen fuel from a storage pressure to a stack operating pressure. The selection of pressure reducing means is not essential to the present power plant, and any suitable pressure reducing means, including reducing valves, expanders, differential pressure regulators or expanded lines, may be employed.

Generally, it is more energetically efficient to dry the hydrogen gas after compression. However, most compressing equipment is adversely affected by water in the gas stream and equipment designed to compress “wet” gases can be significantly more expensive. Thus, for a given application a balance between efficiency and cost will likely determine the order in which the hydrogen gas is dried and compressed.

The electrolysis hydrogen stream need not be compressed prior to storage, however, provided the power plant includes means for moving the hydrogen to the hydrogen storage equipment. For example, a pump may be employed in embodiments of the present power plant wherein the operating pressure of fuel in the stacks is comparable to the hydrogen storage pressure. In other embodiments, the hydrogen storage system comprises a metal hydride storage tank and associated temperature regulating equipment. In electrolysis mode, the hydride storage tank is cooled to facilitate hydrogen storage. This, in turn, creates a partial vacuum that can be employed to move hydrogen from the stacks to the hydride storage tank.

Operation

In power generation mode, hydrogen is consumed at the negative electrodes (anodes) of fuel cells and oxidant is consumed at the positive electrodes (cathodes) to produce electrical power. The electrical power can be supplied to one or more loads. In electrolysis mode, the stacks consume electrical power and water to generate hydrogen and oxygen. In this respect, reference is made to commonly assigned U.S. application Ser. No. ______, filed ______ and entitled “REGENERATIVE FUEL CELL ELECTRIC POWER PLANT AND OPERATING METHOD” (Atty. Docket No. ______).

When operating in electrolysis mode, a power source is connected across stacks and a humidified carrier gas (air in the illustrated embodiments) is supplied thereto. At least a portion of the water present in the humidified carrier gas is electrolyzed in the stacks, generating hydrogen at the negative electrodes (cathodes) of the fuel cells and oxygen at the positive electrodes (anodes). An oxygen-enriched electrolysis exhaust gas exits the stacks, and may be vented to the atmosphere or stored for later use in power generation mode, if desired. The electrolysis exhaust gas typically comprises the carrier gas, oxygen, and water vapor and may also contain carbon dioxide. At least a portion of the hydrogen is stored for later use in power generation mode.

In some embodiments, the present power plant is operated in electrolysis mode once primary power has been restored—typically the power grid—and continues until the hydrogen storage has been replenished.

The applicant has found that the voltage required to sustain a given rate of hydrogen production increases over time in electrolysis mode. Without being bound by theory, the applicant believes that this effect is due to oxidation of the catalyst at the positive electrodes of the fuel cells, which reduces its activity. The applicant has also found that damage to the carbon components of the fuel cells can occur if the voltage of the stack rises above a threshold voltage limit. This is evidenced by an increasing concentration of carbon dioxide in the electrolysis hydrogen gas stream, which correlates with loss of performance and/or lifetime issues for the stacks.

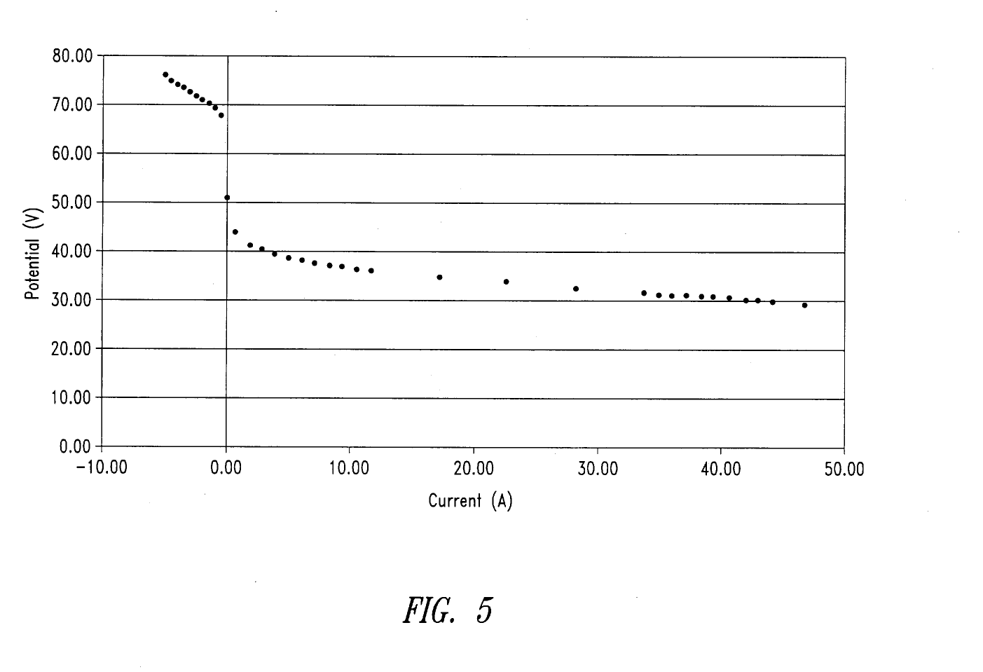

FIG. 5 is a plot of carbon dioxide (CO₂) concentration in the electrolysis exhaust stream as a function of stack voltage for a 47-cell NEXA™ fuel cell module operated in electrolysis mode. The stack was supplied with 60 SLPM of humidified air (25° C., 100% RH) and a constant current source supplied up to 4.0 A to the stack. A sample of the electrolysis exhaust stream was taken at various stack voltages and the CO₂ concentration determined by gas chromatography. At stack voltages greater than 90 V, the CO₂ concentration begins to rise dramatically. Stack performance, in electrolysis or power generation mode, also begins to fall off. Indeed, at stack voltages of 100 V or more, permanent damage to the stack occurs.

In some embodiments, when the present power plant is operated in electrolysis mode a parameter indicative of the oxidation state of the catalyst at the positive electrodes is monitored. Electrolysis mode operation may be interrupted if the measured parameter indicates an undesirable loss in catalytic activity, and resumed at such time that positive electrode catalyst activity has been at least partially restored. For example, the concentration of carbon dioxide in the electrolysis hydrogen stream could be monitored. As another example, cyclic voltammetry could be employed to measure the oxidation state of the catalyst. The particular parameter indicative of the catalyst oxidation, and the method employed to measure it, are not essential to the present invention and persons skilled in the art can select suitable such parameters and measuring methods for a given application.

In some embodiments, the power source is a constant current source that is clamped at a limit voltage. As indicated in FIG. 5, in embodiments of the present power plant incorporating NEXA™ fuel cell stacks a limit voltage of about 90 V—roughly twice the open current voltage of the stack—may be suitable. A suitable limit voltage for a given application may be empirically determined by operating the stacks in electrolysis mode and measuring the concentration of carbon dioxide in the electrolysis hydrogen gas as a function of stack voltage, for example, and identifying a limit voltage that corresponds to an acceptable level of oxidation of the fuel cell components. Persons skilled in the art can readily determine other suitable indicators of component oxidation as a function of stack voltage for a particular type and size of fuel cell stack.

Electrolysis mode operation may be interrupted if the stack voltage reaches or exceeds the limit voltage and resumed at such time that positive electrode catalyst activity has been at least partially restored.

In other embodiments of the present method, the stacks are operated intermittently in electrolysis mode. When the stack voltage reaches or exceeds a predetermined upper voltage limit, electrolysis mode is interrupted by disconnecting the power supply and applying an electrical load to the stack until the stack voltage drops to or below a lower voltage limit. In further embodiments, instead of applying an electrical load to the stack, the stack is shorted until the stack voltage drops to or below a lower voltage limit. Again, without being bound by theory, it is believed that this introduces hydrogen (or hydrogen ions) into the positive electrode space of the fuel cells and consumes oxygen (present as adsorbed oxygen or oxides), which reduces the catalyst and restores its activity. Electrolysis mode may then be resumed. This sequence may be repeated until the hydrogen storage is filled or power generation mode is initiated.

The positive electrode space will contain oxygen as a product of electrolysis; the humidified carrier gas may also be a source of oxygen. The greater the partial pressure of oxygen in the positive electrode space, the more hydrogen will need to be consumed in order to reduce the catalyst to an acceptable degree. This, in turn, may increase the time required to reduce the catalyst and consume an undesirable amount of hydrogen that would otherwise be stored. Thus, in other embodiments, the present method further comprises reducing or interrupting the supply of humidified gas to the stack. Where the carrier gas comprises oxygen, this may reduce the amount of oxygen that must be consumed in order to establish reducing conditions in the positive electrode space. In turn, the amount of time and hydrogen required to reduce the catalyst may be shortened. Where the carrier gas does not comprise oxygen, though, it may be more efficient to continue supply of the humidified gas, as this may flush evolved oxygen from the positive electrode space and assist in establishing reducing conditions.

In electrolysis mode the hydrogen storage of the present power plant may be recharged at a 6×-10× rate, similar to current VRLA battery systems, if desired. This means it would take six to ten times longer operating in electrolysis mode to supply a given amount of hydrogen to the hydrogen storage than it takes to consume the same amount of hydrogen in power generation mode. This permits operation of the stack at lower current in electrolysis mode relative to power generation mode. At lower currents the stack operates at higher efficiency, which may decrease the unit cost of the hydrogen that is generated.

In applications where a longer recharge rate is acceptable (i.e., >10×), the applicant has found that it is possible to operate the present power plant using ambient air as a humidified carrier gas. In order to compensate for the lower water content in ambient air, the stack may be operated at lower currents than is the case with a saturated air stream. Higher air flow rates may also be employed during operation on ambient air.

System Redundancy

As discussed previously, one or more of the fuel cell systems in the present power plant (e.g., 40(M+1)) may serve as a “redundant” fuel cell system. As will be apparent to persons skilled in the art, the concept of redundancy may be applied to various other systems of the present power plant, as well.

For example, it has been disclosed that the fuel cell systems may further comprise an electrical storage device electrically coupled in parallel with the fuel cell stack across a high voltage bus to power the load. Alternatively, such an electrical storage device may be electrically coupled in parallel with the fuel cell stacks of a group of fuel cell systems. By way of illustration, in the array 60 of FIG. 4 each group of series connected fuel cell systems 40 may include one or more electrical storage devices parallel coupled to all or a portion of the constituent fuel cell stacks. Thus, each “arm” of the array may comprise one or more such electrical storage devices.

As another example, where pressurized operation is desired, the fuel cell systems of the array, or groups of them, may share common gas compression equipment; or each fuel cell system may have its own gas compression equipment. As further examples, similar considerations apply with respect to the redundancy of humidification equipment, gas supply and manifolding equipment, and control systems.

From a balance-of-plant perspective, common systems reduce cost and complexity. On the other hand, redundant systems can desirably increase reliability. Multiple systems may also provide a greater degree of control of individual fuel cell systems or portions of the array. The system configuration and degree of redundancy is not essential to the present power plant, and persons skilled in the art can readily select a suitable system configuration for a given application.

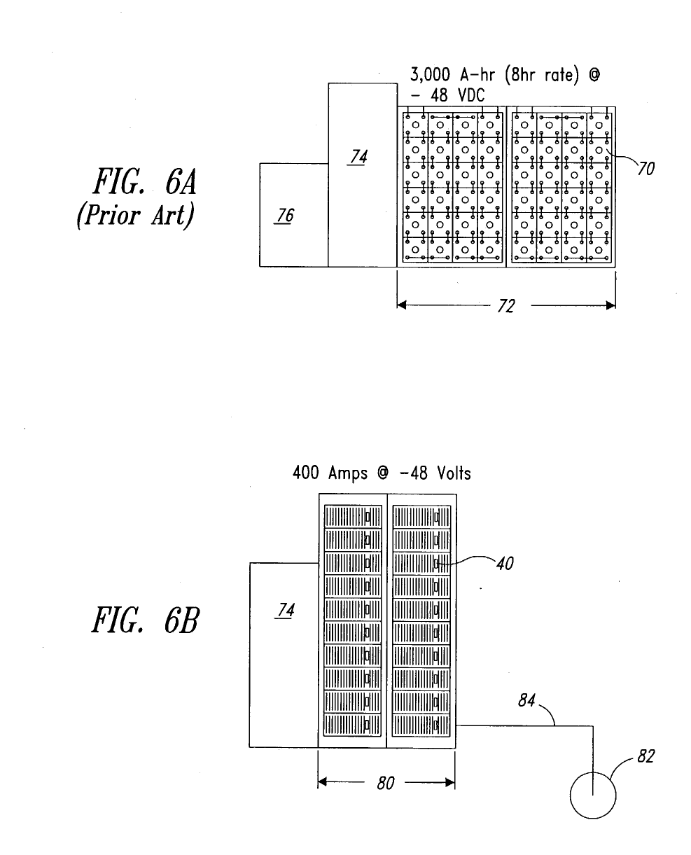

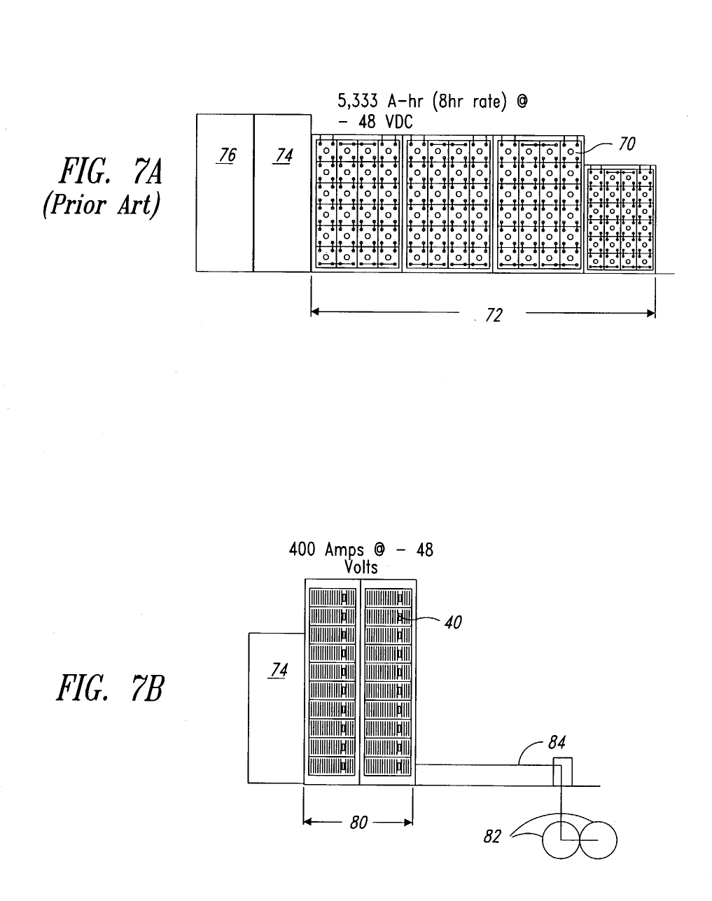

FIGS. 6 and 7 are schematic illustrations of conventional VRLA power supply systems and embodiments of the present power plant. The conventional systems of FIGS. 6 and 7 correspond to battery bank 18 and rectifier 10 of FIG. 1.

The systems illustrated in FIGS. 6a and 6b are capable of providing power at 400 A/48 VDC for 4 hours (400 A 4 hr back up). In FIG. 6a, the power grid normally supplies load power via rectifier 74. When the power grid is interrupted, VRLA batteries 70 in battery bank 72 provide load power. Once the grid is restored, it supplies power to rectifier 76 in order to recharge battery bank 72.

The embodiment of FIG. 6b comprises an array 80 of fuel cell systems 40 configured to provide 400 A/48 VDC power. Array 80 has ten sets of two fuel cell systems: the two fuel cell systems in each set electrically coupled in series, and each set electrically coupled in parallel. Each fuel cell system 40 comprises a 47-cell PEM fuel cell stack producing 1 kW at 24 volts and 40 amps, electrically coupled in parallel to two 12 VDC VRLA batteries. When grid power is interrupted, hydrogen from hydrogen supply 82 is supplied to the fuel cells of array 80 via supply line 84; air is also supplied to the fuel cells from an appropriate integrated supply (not shown) that also provides air as the humidified carrier gas in electrolysis mode. Electric power generated by array 80 is then supplied to the load. Once grid power is restored, array 80 may be operated in electrolysis mode, as described, to replenish hydrogen storage 82. Water is obtained from the municipal supply and deionized before being supplied for humidification. In the embodiment of FIG. 6b, hydrogen supply 82 is a 100 gal. (380 l) 3600 psi (25 MPa) hydrogen tank, which holds sufficient hydrogen for array 80 to continuously supply load power for 4 hours.

The dimensions, weight and footprint of the 400 A 4 hour systems of FIGS. 6a and 6b are summarized in Table 1. The size and weight of battery bank 72 is based on currently available VRLA battery banks. The battery bank rating used in the comparison is based on a 10× recharge rate and assumes a constant current load. The rectifier rating is based on the load current plus a 0.1 C battery charging current. Front clearance refers to area between adjacent walls and the back and sides of the power supply required by safety regulations.

TABLE 1
Comparison of 400 A/48 VDC 4 hour back-up power systems

| VRLA Battery Bank | | Fuel Cell Array | |
|---|---|---|---|
| Battery Rating | 3000 A-hr | Array Rating | 400 A @ 48 VDC |
| Battery Size | Width: 93 in (236 cm) | Array Size | Width: 48 in (122 cm) |
| | Depth: 21 in (53 cm) | | Depth: 36 in (91 cm) |
| | Height: 72 in (183 cm) | | Height: 84 in (213 cm) |
| Battery Weight | 13,725 lbs. (6020 kg) | Array Weight | 2000 lbs. (910 kg) |
| Footprint | 13.6 ft² (1.3 m²) | Footprint | 12.0 ft² (1.1 m²) |
| Floor Loading | 979 lbs./ ft² (149 kgf/m²) | | 167 lbs./ft² (25.3 kgf/m²) |
| Rectifier Rating | 700 A @ 54 VDC | Rectifier Rating | 410 A @ 54 VDC |
| Rectifier Size | Width: 48 in (122 cm) | Rectifier Size | Width: 24 in (61 cm) |
| | Depth: 21 in (53 cm) | | Depth: 3 6 in (91 cm) |
| | Height: 72 in (183 cm) | | Height: 72 in (183 cm) |
| Rectifier Footprint | 7.0 ft² (0.65 m²) | Rectifier Footprint | 6.0 ft² (0.56 m²) |
| Front Clearance | Width: 141 in (358 cm) | Front Clearance | Width: 72 in (183 cm) |
| | Depth: 36 in (91 cm) | | Depth: 36 in (91 cm) |
| Clearance | 35.3 ft² (3.3 m²) | Clearance | 18.0 ft² (1.7m²) |
| Footprint | | Footprint | |
| Total Footprint | 55.9 ft² (5.2 m²) | Total Footprint | 36 ft² (3.3 m²) |

The systems illustrated in FIGS. 7a and 7b are configured to provide 400 A/48 VDC power for 8 hours (400 A 8 hr back up). Array 80 is as described in FIG. 6b. Because of the longer run time, hydrogen storage 82 in FIG. 7b comprises 2×100 gal. (380 l) 3600 psi (25 MPa) hydrogen tanks.

The dimensions, weight and footprint of the 400 A 8 hour systems of FIGS. 7a and 7b are summarized in Table 2. The comparative data is based on the same assumptions given for the data in Table 1.

TABLE 2
Comparison of 400 A/48 VDC 8 hour back-up power systems

| VRLA Battery Bank | | Fuel Cell Array | |
|---|---|---|---|
| Battery Rating | 5333 A-hr | Array Rating | 400 A @ 48 VDC |
| | | Battery Rating | 104 A-hr |
| Battery Size | Width: 165 in (420 cm) | Array Size | Width: 48 in (122 cm) |
| | Depth: 21 in (53 cm) | | Depth: 36 in (91 cm) |
| | Height: 72 in (183 cm) | | Height: 84 in (213 cm) |
| Battery Weight | 23,585 lbs. (10,700 kg) | Array Weight | 2000 lbs. (910 kg) |
| Footprint | 24.1 ft² (2.2 m²) | Footprint | 12.0 ft² (1.1 m²) |
| Floor Loading | 979 lbs./ft² (149 kgf/m²) | | 167 lbs./ ft² (25.3 kgf/m²) |
| Rectifier Rating | 933 A @ 54 VDC | Rectifier Rating | 410 A @ 54 VDC |
| Rectifier Size | Width: 72 in (183 cm) | Rectifier Size | Width: 24 in (61 cm) |
| | Depth: 21 in (53 cm) | | Depth: 36 in (91 cm) |
| | Height: 72 in (183 cm) | | Height: 72 in (183 cm) |
| Rectifier Footprint | 10.5 ft² (0.98 m²) | Rectifier Footprint | 6.0 ft² (0.56 m²) |
| Front Clearance | Width: 237 in (602 cm) | Front Clearance | Width: 72 in (183 cm) |
| | Depth: 36 in (91 cm) | | Depth: 36 in (91 cm) |
| Clearance | 59.3 ft² (5.5 m²) | Clearance | 18.0 ft² (1.7 m²) |
| Footprint | | Footprint | |
| Total Footprint | 93.9 ft² (8.7 m²) | Total Footprint | 36 ft² (3.3 m²) |

As previously mentioned, there are environmental concerns relating to current VRLA battery-based power supplies. Environmental regulations relating to the storage and operation of the batteries increases the cost of the power supply. Furthermore, the risk of liability for hazardous/toxic site clean-up in the event of an accidental discharge of battery components is significant.

As shown in Tables 1 and 2, even embodiments of the present power plant incorporating VRLA batteries significantly reduce the costs and potential environmental liability associated with current VRLA battery-based power supplies. For example, the power supply of FIG. 6b requires 95.4% less batteries than the conventional system of FIG. 6a. Between the power supplies of FIGS. 7a and 7b, there is a 97.4% reduction in the number of VRLA batteries employed. Of course, in other embodiments of the present power supply that do not include energy storage devices, VRLA batteries may be eliminated entirely.

Tables 1 and 2 also show the reduction in weight and footprint of the present power supply compared to conventional VRLA battery-based power supplies. The embodiments of FIGS. 6b and 7b represent area savings of 19.9 ft² (1.9 m²) and 57.9 ft² (5.4 m²), respectively, compared to the conventional systems. For many point-of-presence applications, where the costs of housing the power supply can reach or exceed $US 650.00/ft², the smaller footprint of the present power plant alone can provide significant cost savings. Additional cost savings may be realized due to the smaller size and footprint of the rectifier required for the embodiments of the present power plant compared to the conventional power supplies.

The data in Tables 1 and 2 does not take into account the dimensions and footprint of the hydrogen storage associated with the power plants of FIGS. 6b and 7b. This is because the hydrogen storage does not have to be situated with the rest of the power plant. In conventional power supplies, the batteries are both the energy storage device and the electrical power source. As a practical matter, the battery banks must be situated close to the power distribution panel and/or load, since power losses in DC systems increase dramatically with the distance from the power source. In the present power plant, the energy storage device is decoupled from the electrical power source; hence, the hydrogen storage equipment may be placed any desired distance from the fuel cell array. Thus, it is not necessary to store the hydrogen storage equipment indoors with the rest of the present power plant and, therefore, to include it in the footprint analysis.

The decoupling of energy storage and power supply in the present power plant may provide significant advantages over current battery systems. Hydrogen storage equipment could be placed outside, in an out-building or in an underground facility, for example. In certain telecom applications, for example, communications equipment is often situated on the roof of a building. Most building codes will not permit a VRLA battery bank to be installed on the roof, so the back-up power supply must be installed some distance from the equipment. As mentioned earlier, this arrangement can result in significant power losses in providing power from the batteries to the load(s). With the present power plant, on the other hand, the fuel cell array may be installed on the roof, because of its lower floor loading, and hydrogen could be supplied from hydrogen storage equipment located any distance from the equipment, without an attendant power loss.

Furthermore, a low-cost underground facility could be used for the hydrogen storage equipment. Indeed, it may be possible to simply bury hydrogen tanks, for example, near the facility housing the fuel cell array: this is because hydrogen does not contaminate groundwater, but will percolate out of the soil in case of a leak. The fact that hydrogen does not pollute groundwater means that expensive containment vessels, such as required for diesel or other fuel tanks, are not required. Thus, hydrogen storage may be less costly and more environmentally friendly than other options.

In fact, conventional power supplies, such as shown in FIG. 6a or 7a, could be upgraded to an embodiment of the present power supply by replacing the battery bank with a suitably sized fuel cell array and hydrogen storage. Existing rectifiers employed for recharging the batteries could be eliminated or used to increase the output of the power supply. Take, for example, the conventional 400 A 4 hour back-up power supply of FIG. 6a. Because the fuel cell array 80 of the present power plant does not require rectifier 76 for recharging, two rectifiers 74 may be employed to supply load power, if desired. Thus, the power supply of FIG. 6a could be upgraded to an 800 A power supply. Furthermore, by suitably selecting the capacity of the hydrogen storage, the upgraded system could supply back-up power for 4-8 hours, or more. At the same time, the upgraded system would have a smaller footprint.

While the illustrated embodiments are described as −48 VDC systems, the present power plant is not limited to such systems. For example, the present power plant may be configured to provide −12 VDC power, or DC power of any desired voltage. Similarly, the present power plant may be configured to provide AC power. For example, by substituting rectifier 74 in FIG. 6b or 7b with an inverter, the illustrated embodiments would be suitable for use as an AC power supply system.

Generally, the present power plant may be employed in a back-up power or UPS system for a range of applications, including, but not limited to:

1. Network server farms: LAN/WAN equipment such as hubs and routers.

2. Communications: CATV, radio, telecommunications storage systems and/or servers, wireless base stations, radar tracking systems.

3. Computer rooms: small and mid-range servers, large enterprise servers, data storage systems, network computer clusters, internet data centers.

4. Desktop/Workstations: stand-alone PCs, workstations and computer peripherals.

5. Industrial/Commercial: process control equipment, medical equipment, laboratory instrumentation, traffic management systems, security equipment, point of sale equipment.

In addition, the present power supply may also be used in peak power or distributed power applications.

The present power plant and operating method provide for a system that is smaller and lighter than conventional power supply systems employing VRLA batteries. The present power plant may also provide for “instant on” operation with improved hydrogen consumption rates as compared to systems in which fuel cell stacks are continuously running.

The present power plant also provides for hydrogen generation and storage at lower cost and complexity compared to power supply systems employing fuel cell stacks and electrolyzers.

The present power plant and operating method further provide for operation of a stack in electrolysis mode using a humidified carrier gas instead of liquid water. This may shorten the delay in providing power when switching from electrolysis mode to power generation mode, since liquid water need not be purged from the cells in order to generate power. In addition, this may provide for increased operational lifetime, as fuel cell components cannot be washed out of the stack.

All of the above U.S. patents, U.S. patent application publications, U.S. patent applications, foreign patents, foreign patent applications and non-patent publications referred to in the this specification and/or listed in the Application Data Sheet, are incorporated herein by reference in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An electric power plant comprising:
a power supply system comprising a power bus, a first fuel cell system comprising a fuel cell stack, a second fuel cell system comprising a fuel cell stack, a first switch selectively operable to electrically couple the first fuel cell system in series in the power bus, and a second switch selectively operable to electrically couple the second fuel cell system in series in the power bus, the fuel cell systems each comprising a regenerative fuel cell stack;
an oxidant supply system for supplying an oxidant gas to the fuel cell stacks;
a fuel supply system for supplying a fuel gas to the fuel cell stacks;
a system for supplying a humidified carrier gas to the fuel cell stacks;
a DC current supply system for connecting a power source across the fuel cell stacks; and,
a storage system for storing hydrogen received from the fuel cell stacks.

2. The power plant of claim 1, further comprising a rectifier electrically connected to an AC power source.

3. The power plant of claim 1, further comprising an inverter electrically connected to the power supply system.

4. The power plant of claim 1 wherein each of the fuel cell stacks is a regenerative fuel cell stack and each of the fuel cell systems further comprise first electrical storage device electrically coupled in parallel with the fuel cell stack.

5. The power plant of claim 1 wherein the power supply system further comprises a third fuel cell system comprising a regenerative fuel cell stack, and a third switch selectively operable to electrically couple the third fuel cell system in series in the power bus.

6. The power plant of claim 1 wherein the power supply system further comprises a third fuel cell system comprising a regenerative fuel cell stack, and a third switch selectively operable to electrically couple the third fuel cell system in the power bus in parallel with at least one of the first and second fuel cell systems.

7. The power plant of claim 1 wherein the oxidant comprises air.

8. The power plant of claim 7 wherein the oxidant supply system comprises gas compression equipment for supplying the air to the stacks at greater than ambient pressure.

9. The power plant of claim 1 wherein the carrier gas comprises air.

10. The power plant of claim 1 wherein the oxidant supply system and the system for supplying humidified carrier gas to the stack are integrated.

11. The power plant of claim 1 wherein the power source comprises a rectifier electrically connected to the power grid.

12. The power plant of claim 1 wherein the storage system comprises a pressurized hydrogen tank.

13. The power plant of claim 1 wherein the fuel cell stacks comprise polymer electrolyte membrane fuel cells.

14. An electric power plant comprising:
an array of fuel cell systems, the fuel cell systems each comprising a regenerative fuel cell stack;
an oxidant supply system for supplying an oxidant gas to the fuel cell stacks;
a fuel supply system for supplying a fuel gas to the fuel cell stacks;
a system for supplying a humidified carrier gas to the fuel cell stacks;
a DC current supply system for connecting a power source across the fuel cell stacks; and,
a storage system for storing hydrogen received from the fuel cell stacks.

15. The power plant of claim 14 wherein the array comprises a power bus and a first arm comprising a first plurality of fuel cell systems electrically couplable to the power bus and electrically couplable in series to each other.

16. The power plant of claim 15 wherein the first arm of the array includes at least one redundant fuel cell system.

17. The power plant of claim 15 wherein the first arm of the array includes an electrical storage device electrically coupled in parallel with one or more of the fuel cell stacks.

18. The power plant of claim 15 wherein the array further comprises a second arm comprising a second plurality of fuel cell systems electrically couplable to the power bus and electrically couplable in series to each other, the second arm electrically couplable in parallel to the first arm.

19. The power plant of claim 18 wherein at least one of the first and the second arms of the array includes at least one redundant fuel cell system.

20. The power plant of claim 18 wherein at least one of the first and the second arms of the array includes an electrical storage device electrically coupled in parallel with one or more of the fuel cell stacks thereof.

21. The power plant of claim 14 wherein the each of fuel cell systems further comprises an electrical storage device electrically coupled in parallel with a respective one of the fuel cell stacks.

22. The power plant of claim 21 wherein the electrical storage device comprises a storage battery or a super capacitor.

23. The power plant of claim 14 wherein at least one of the oxidant and fuel supply systems comprises means for humidifying a reactant gas supplied to the fuel cell stacks.

24. The power plant of claim 23 wherein the means for humidifying the reactant gas is integrated with a means for humidifying the carrier gas.

25. The power plant of claim 14 wherein the storage system comprises hydrogen storage equipment.

26. The power plant of claim 25 wherein the hydrogen storage equipment comprises pressurized hydrogen tanks.

27. The power plant of claim 25 wherein the storage system further comprises means for removing water from the hydrogen received from the fuel cell stacks.

28. The power plant of claim 25 wherein the storage system further comprises means for moving the hydrogen received from the fuel cell stacks to the hydrogen storage equipment.

29. The power plant of claim 25 wherein the storage system further comprises means for compressing the hydrogen received from the fuel cell stacks.

30. The power plant of claim 25 wherein at least one of the fuel supply and storage systems comprises means for reducing a hydrogen storage pressure to a stack operating pressure.

31. The power plant of claim 14 wherein the power source is clamped at a predetermined limit voltage.

32. The power plant of claim 31 wherein the limit voltage is about twice the open circuit voltage of the fuel cell stacks.

33. The power plant of claim 14 wherein the fuel cell stacks comprise polymer electrolyte membrane fuel cells.
